(19) United States
(12) Patent Application Publication
(10) Pub. No.: US 2013/0107083 A1
(43) Pub. Date: May 2, 2013

(54) Method of Noise Reduction in Image and Device Thereof

(71) Applicant: Wei Hsu, Taoyuan County (TW)

(72) Inventor: Wei Hsu, Taoyuan County (TW)

(21) Appl. No.: 13/365,275

(22) Filed: Feb. 3, 2012

(30) Foreign Application Priority Data
Oct. 26, 2011 (TW) 100138839

(51) Int. Cl. H04N 9/64; G06K 9/00

(52) U.S. Cl. 348/242; 382/167; 348/E09.01; 348/E09.042

(57) ABSTRACT

Method of noise reduction in an image includes capturing the image including a plurality of pixels each corresponding to a color via an image sensor, selecting a target pixel of the plurality of pixels, generating a noise threshold value associated to the target pixel according to a noise variation function related to noise distribution range of the image sensor, calculating a difference value between the target pixel and a neighbor pixel having the same color with the target pixel, comparing the difference value and the noise threshold value to determine whether the neighbor pixel is a noise to the target pixel, and when determining the neighbor pixel is a noise to the target pixel, performing a smooth operation to lower the noise of the target pixel.

### BACKGROUND OF THE INVENTION

1. Field of the Invention

The present invention relates to a method of noise reduction in image and device thereof, and more particularly, to a method of noise reduction in image and device thereof with utilizing noise distribution to lower image noise.

2. Description of the Prior Art

Due to the popularity of digital camera and displayer, the demand of digital image processing technology for industry and consumers increases. No matter how the camera product standards are ideal, there is no an image absolutely perfect, the image is influenced by the noise. In a digital image, the noise mainly appears during the image capturing, digitalizing and/or transmission. The performance of an image sensor is influenced by many factors, such as the environment of image capturing and the quality of the sensor. For example, in a charge-coupled device (CCD), the luminance is an important factor for generating the noise to the image.

Filtering the digital image to reduce the noise is a necessary step in an image process to protect the sharpness of the image. For example, in an image signal, high frequency components relate to the characteristics of object edge and texture, thus, the concept of image sharpen is to enhance the high frequency components of the image signal, so as to improve the sharpness of the image. However, during the image signal production or transmission, the noise is more or less generated resulting in the image signal having the noise component. Therefore, a noise reduction operation to the image is necessary before capturing the high frequency components. If not, the noise to the high frequency component is enhanced and included to the original image during the image sharpen process, which decreases the quality of the image.

In practice, the noise reduction operation utilizes a noise filtering technology to enhance the sharpness of the image, e.g. spatial filter, bilateral filter and temporal filter. The spatial filter, such as a box filter or Gaussian filter, can not distinguish the noise from the image signal during noise reduction process. Though a filtering coefficient for defining different filtering level, the sharpness of the image, e.g. texture or edge, may become blur. The bilateral filter is realized by multiplying the space and the luminance, the bilateral filter can smoothly reduce the noise with smaller luminance variation in the image, while keep the image edge with greater luminance variance. But the calculation is too complicated, and only the relation of luminance and noise is taking into consideration, the noise still can be removed effectively. The temporal filter utilizes a difference between two continuous images to obtain a noise character, so that the noise reduction can not be performed in a single image, and which also limited in the memory of the system.

### SUMMARY OF THE INVENTION

It is therefore an object of the present invention to provide a method of noise reduction in image and device thereof for effectively separating noise from image signal to filter out the noise and reserve image sharpness.

The present invention discloses a method of noise reduction in an image, comprising capturing the image including a plurality of pixels each corresponding to a color via an image sensor, selecting a target pixel of the plurality of pixels, generating a noise threshold value associated to the target pixel according to a noise variation function related to noise distribution range of the image sensor, calculating a difference value between the target pixel and a neighbor pixel having the same color with the target pixel, comparing the difference value and the noise threshold value to determine whether the neighbor pixel is a noise to the target pixel, and when determining the neighbor pixel is a noise to the target pixel, performing a smooth operation to lower the noise of the target pixel.

The present invention further discloses a noise processing device, for reducing a noise to an image captured by an image sensor, the noise processing device comprises a selecting unit for selecting a target pixel of a plurality of pixels each corresponding to a color in the image, an operating unit for generating a noise threshold value associated to the target pixel according to a noise variation function related to a noise distribution range of the image sensor, a comparing unit for calculating a pixel difference value of the target pixel and a neighbor pixel having the same color with the target pixel, a determining unit for comparing the pixel difference value with the noise threshold value, to determine whether the neighbor pixel is the noise to the target pixel, and a filter for performing a pixel smooth operation when the neighbor pixel is determined to be the noise to the target pixel, to lower the noise to the target pixel.

The present invention further discloses an image processing system, comprising an image capturing device comprising an image sensor for capturing an image including a plurality of pixels each corresponding to a color, and an image processing device for receiving the image captured by the image capturing device, and performing at least one image procedure to the image, the image processing device comprises a noise processing device for reducing the noise to the image, the noise processing device comprising a selecting unit for selecting a target pixel of the plurality of pixels, an operating unit for generating a noise threshold value associated to the target pixel according to a noise variation function related to a noise distribution range of the image sensor, a comparing unit for calculating a pixel difference value of the target pixel and a neighbor pixel having the same color with the target pixel, a determining unit for comparing the pixel difference value with the noise threshold value, to determine whether the neighbor pixel is the noise to the target pixel, and a filter for performing a pixel smooth operation when the neighbor pixel is determined to be the noise to the target pixel, to lower the noise to the target pixel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an image processing system according to an embodiment of the present invention.

FIG. 2 is a schematic diagram of a noise reduction process according to an embodiment of the present invention.

FIG. 3 is a noise distribution probability diagram of an image sensor according to an embodiment of the present invention.

FIG. 4 is a diagram of the noise standard deviation versus luminance of an image sensor according to an embodiment of the present invention.

FIG. 5 is a diagram of the noise standard deviation versus luminance of an image sensor according to an embodiment of the present invention.

FIG. 6 is a relation diagram between the luminance gain compensation versus the noise standard deviation of an image sensor according to an embodiment of the present invention.

FIG. 7 is a schematic diagram of a noise processing device according to an embodiment of the present invention.

FIG. 8 is a schematic diagram of a pixel window according to an embodiment of the present invention.

### DETAILED DESCRIPTION

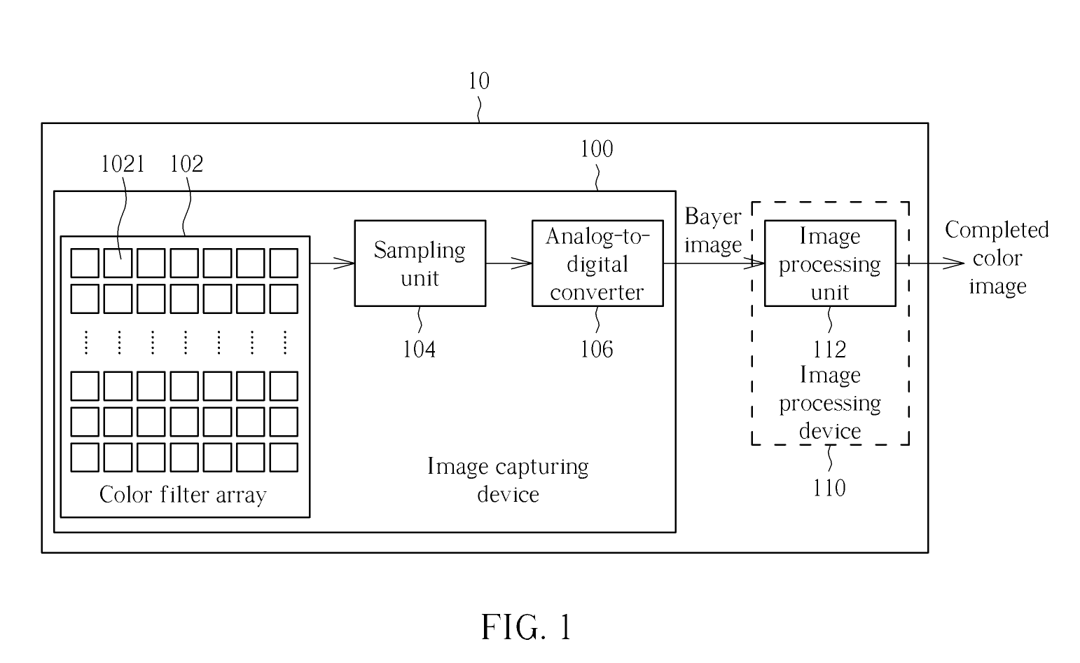

Please refer to FIG. 1, which is a schematic diagram of an image processing system 10 according to an embodiment of the present invention. The image processing system 10 includes an image capturing device 100 and an image processing device 110. The image capturing device 100 includes an image sensor, e.g. a charge-coupled device (CCD), a sampling unit 104 and an analog-to-digital converter (ADC) 106. The image sensor is used for capturing an image, and includes a color filter array (CFA) 102 for generating a pixel array related to the image, wherein each pixel of the pixel array corresponds to a color filter 1021 and accordingly corresponds to a color of a plurality of colors, such as red, blue or green. After the pixel array has been sampled by the sampling unit 104, and performed analog-to-digital conversion by the ADC 106, the pixel array is outputted to the image processing device 100. Take a Bayer color filter array as an example for simply illustrating the mentioned color filter array. The image processing device 110 is used for receiving an image data, which may refer to as a Bayer image, outputted from the image capturing device 100, and the image processing unit 112 performs a specific image procedure to the image data, such as pixel compensation, color interpolation and image enhancement. After the specific image procedure is finished, the image processing device 110 outputs the completed color image.

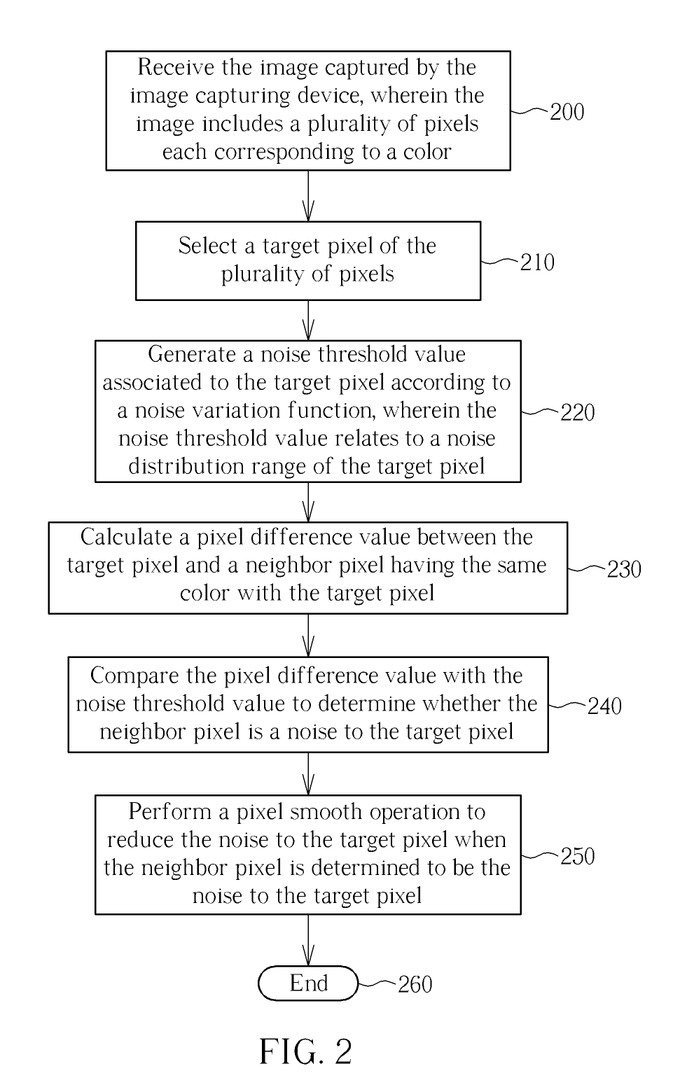

Please refer to FIG. 2, which is a schematic diagram of a noise reduction process 20 according to an embodiment of the present invention. The noise reduction process 20 may be used for the image processing device 110, and includes following steps:

Step 200: Receive the image captured by the image capturing device 100, wherein the image includes a plurality of pixels each corresponding to a color.

Step 210: Select a target pixel of the plurality of pixels.

Step 220: Generate a noise threshold value associated to the target pixel according to a noise variation function, wherein the noise threshold value relates to a noise distribution range of the target pixel.

Step 230: Calculate a pixel difference value between the target pixel and a neighbor pixel having the same color with the target pixel.

Step 240: Compare the pixel difference value with the noise threshold value to determine whether the neighbor pixel is a noise to the target pixel.

Step 250: Perform a pixel smooth operation to reduce the noise to the target pixel when the neighbor pixel is determined to be the noise to the target pixel.

Step 260: End.

According to the noise reduction process 20, the image processing device 110 selects a target pixel, and calculates the noise threshold value associated to the target pixel according to the noise variation function. Then, the image processing device 110 calculates the pixel difference value between the target pixel and the neighbor pixel having the same color with the target pixel, e.g. red, blue or green, and compares the pixel difference value with the noise threshold value, so as to determine whether the neighbor pixel is the noise to the target pixel. When the pixel difference value is less than the noise threshold value, the neighbor pixel is determined to be the noise to the target pixel; while the pixel difference value is greater than the noise threshold value, the neighbor pixel is determined to be an edge pixel in stead of the noise to the target pixel. Besides, when the neighbor pixel is determined to be the noise, the image processing device 110 calculates a pixel average value of the target pixel and the neighbor pixel via a pixel smooth operation, and utilizes the pixel average value as a new pixel value of the target pixel, so as to lower the noise to the target pixel, such that the smoother image is obtained. Noticeably, when the neighbor pixel is determined not to be the noise, neither the neighbor pixel nor the target pixel are used for performing the smooth operation, so as to avoid blurring a sharpness of the image.

Furthermore, the present invention is not limited to comparing the pixel difference value between the target pixel and the single neighbor pixel with the noise threshold value. For example, in an embodiment, the image processing device 110 may define a pixel window with a specific size according to a position of the target pixel. All pixels in the pixel window and having the same color with the target pixel may be regarded as the neighbor pixel, such that the image processing device 110 compares the pixel difference value between each neighbor pixel and the target pixel with the noise threshold value, so as to determine whether each of the neighbor pixel is a noise respectively, and thus determine whether to perform the pixel smooth operation accordingly. As a result, the noise to the image is improved and the sharpness of the image is maintained as well.

Noticeably, a noise threshold value “Adaptive_Thr” is obtained from an operation of the noise variation function, and the noise variation function is designed according to characteristics of an image sensor. The noise variation function includes a minimum STD parameter “REG_Min_STD”, a target pixel value “Pixel_Value”, a noise distribution probability parameter “REG_Std_Percentage”, a parameter of luminance and STD “REG_Lum_Slope” and a gain compensation parameter “REG_ISO_Speed_Gain”. In detail, a formula for calculating the noise threshold value “Adaptive_Thr” can be denoted as follow:

Adaptive_Thr=REG_Min_STD+Pixel_Value×REG_Std_Percentage×REG_Lum_Slope×REG_ISO_Speed_Gain

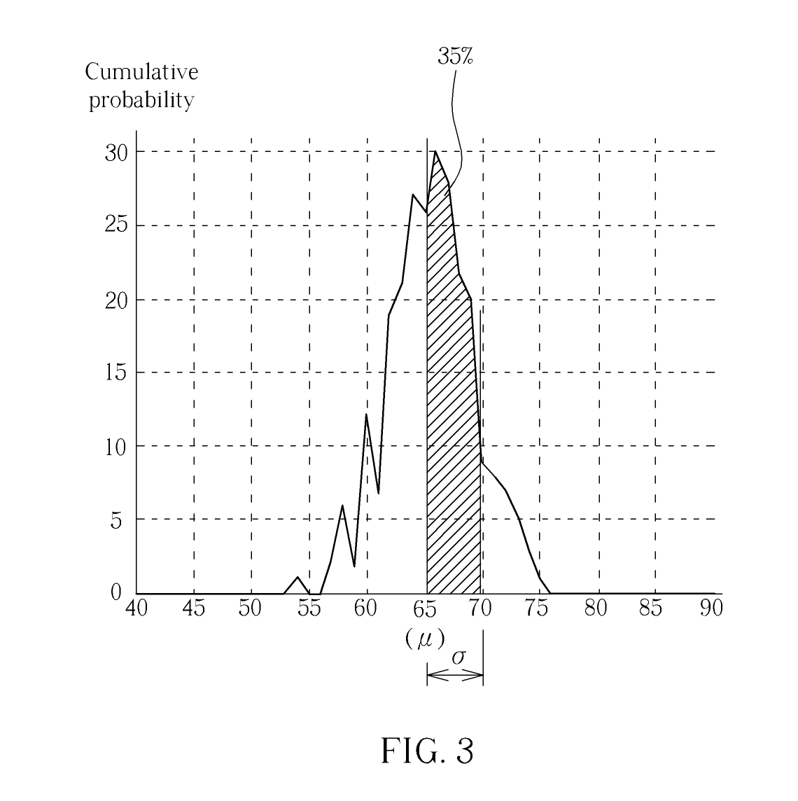

Please refer to FIG. 3 to FIG. 6. FIG. 3 is a noise distribution probability diagram of an image sensor according to an embodiment of the present invention. In general, the noise distribution of the image sensor is usually to be a Gaussian distribution, which can be described via a probability density function, i.e. a mean and a standard deviation (STD). In the embodiment of the present invention, the noise distribution probability parameter “REG_Std_Percentage” is used for indicating how much percentage of the noise falls within the standard deviation range. For instance, in FIG. 3, assumed a mean μ is 65, a STD value σ is 5, and 35% noise falls within the range of one STD value. Noticeably, the noise distribution probability parameter “REG_Std_Percentage” is not limited to the noise percentage within one STD value, the noise percentage may also be within 2 STD values or more according to a level of noise reduction by the noise reduction process 20. For example, according to the formula of calculating the noise threshold value “Adaptive_Thr”, comparing 50% noise reduction and 30% noise reduction, the noise threshold value “Adaptive_Thr” is greater for 50% noise reduction. The probability of the neighbor pixel of the target pixel being the noise is increased, such that the noise reduction to the target pixel is increased as well. In other words, the noise variation changes dynamically as the noise distribution probability parameter “REG_Std_Percentage” changes.

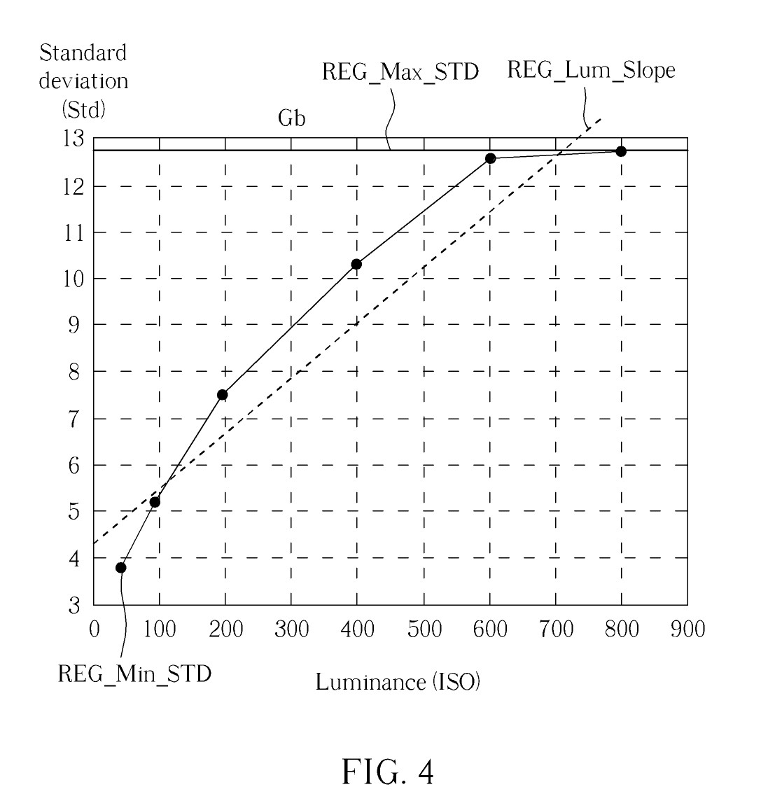

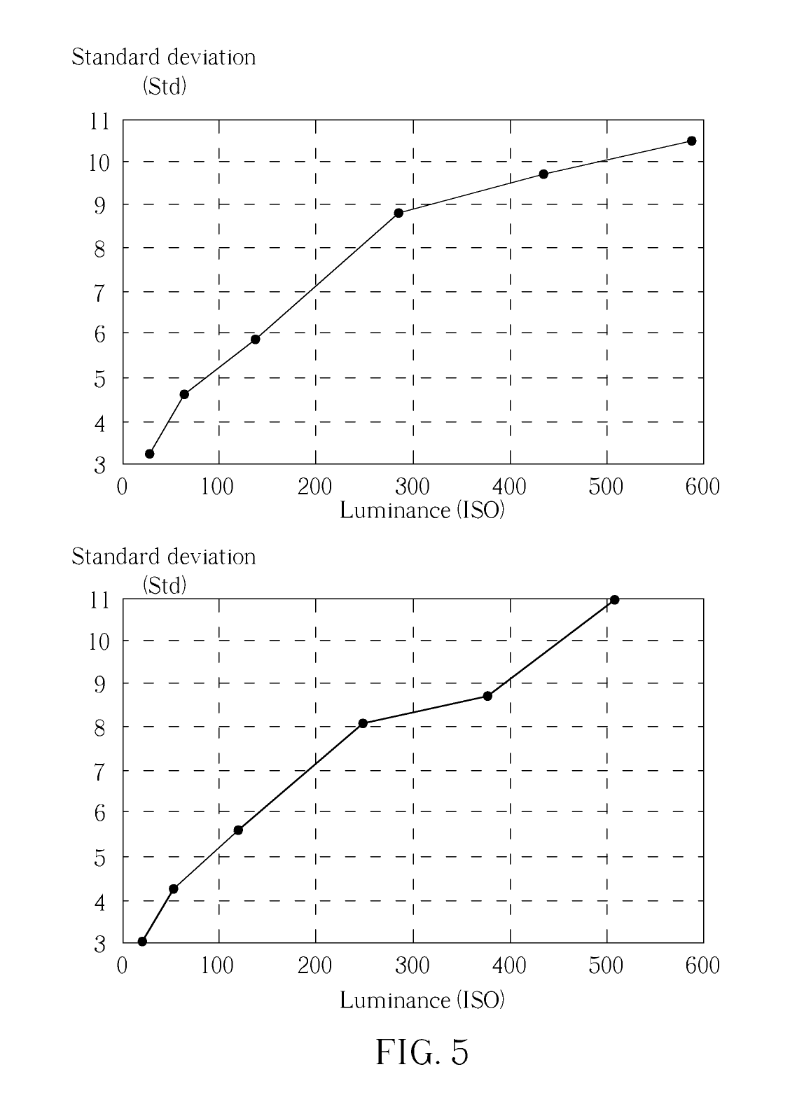

Please refer to FIG. 4, which is a diagram of the noise standard deviation versus luminance of an image sensor according to an embodiment of the present invention. As shown in FIG. 4, as a luminance ISO increases, the noise distribution (i.e. STD) of the image sensor increases. However, as the luminance ISO increases, the STD converges to a maximum value, which is referred to as a maximum STD parameter “REG_Max_STD”; as the luminance ISO closes to zero, the STD converges to a minimum value, which is referred to as the minimum STD parameter “REG_Min_STD”. As can be seen from FIG. 4, the noise variation of the image sensor is influenced by the luminance ISO, i.e. the higher luminance ISO, the higher noise variation. In the embodiment of the present invention, the relationship between the luminance ISO and the STD is obtained via utilizing a second order linear regression line to calculate a slope of the function, i.e. the parameter of luminance and STD “REG_Lum_Slope”, so as to predict the noise variation of the image sensor. As a result, the noise variation changes dynamically according to the parameter of luminance and STD “REG_Lum_Slope” and the minimum STD parameter “REG_Min_STD”. Noticeably, as shown in FIG. 5, the relationship between the luminance ISO and STD differs for different colors, e.g. red “Red”, blue “B” and green “Gb”, “Gr”, such that the noise variation changes as color changes, and thus the parameter of luminance and STD “REG_Lum_Slope” changes as well.

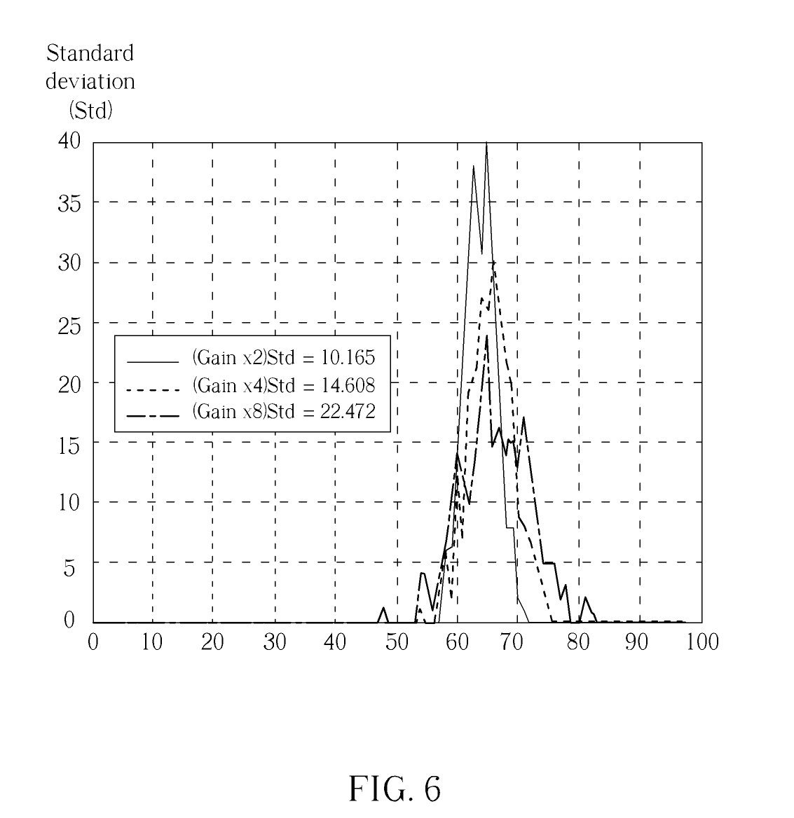

Please refer to FIG. 6, which is a relation diagram between the luminance gain compensation versus the noise standard deviation of an image sensor according to an embodiment of the present invention. As shown in FIG. 6, the noise distribution of the image sensor increases as the luminance gain Gain increases. For example, when the luminance gain is (Gain×2), i.e. the luminance Gain is doubled, the noise standard deviation is 10.165; when the luminance gain is (Gain×4), i.e. the luminance Gain is four times, the noise standard deviation is 14.608. As can be seen, the noise variation of the image sensor is influenced by the increment of the luminance gain Gain, which means the greater luminance gain Gain, the greater noise variation. In an embodiment, increasing the gain compensation parameter “REG_ISO_Speed_Gain” is used for indicating the relationship between the luminance gain Gain and the STD. According to above description, the noise variation changes dynamically as the gain compensation parameter “REG_ISO_Speed_Gain” changes.

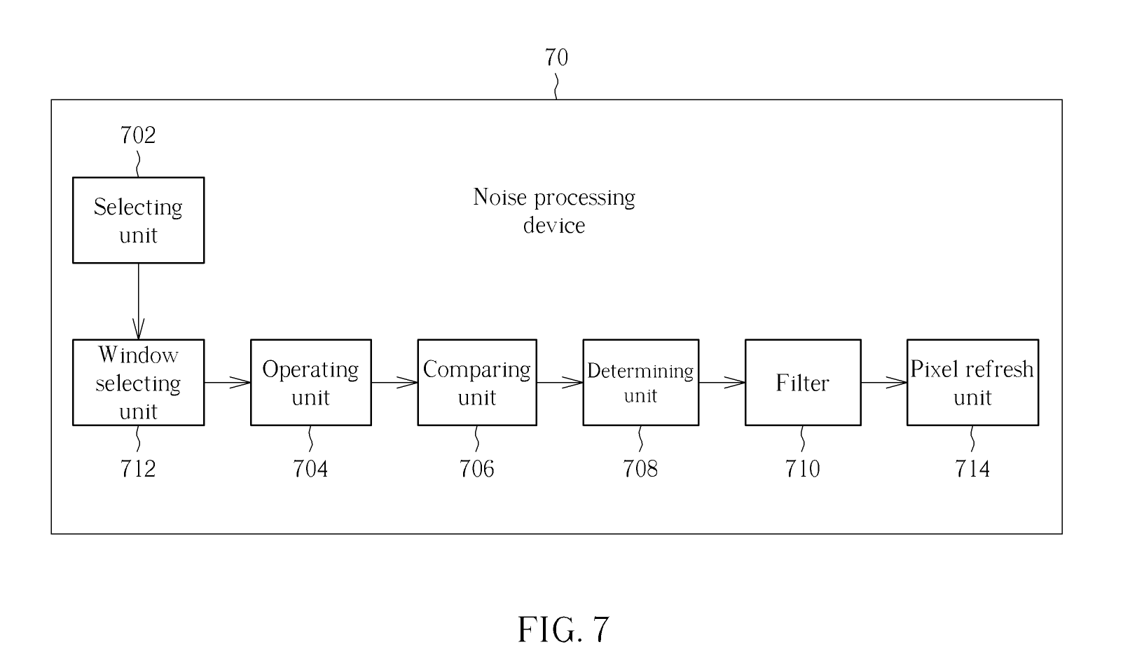

Those skilled in the art may realize the noise reduction process 20 by means of software, hardware or their combinations. For example, please refer to FIG. 1. The image processing device 110 includes a memory, which may be any data storage devices, such as a read-only memory (ROM), for storing a program code compiled from the noise reduction process 20, thereafter read and processed by a processor to execute and realize steps of the noise reduction process 20. Or, please refer to FIG. 7, which is a schematic diagram of a noise processing device 70 according to an embodiment of the present invention. The noise processing device 70 includes a selecting unit 702, an operating unit 704, a comparing unit 706, a determining unit 708, a filter 710, a window selecting unit 712 and a pixel refresh unit 714. The selecting unit 702 is used for selecting a target pixel of a plurality of pixels of an image. The operating unit 704 is used for generating a noise threshold value associated to the target pixel according to a noise variation function related to the noise distribution range of the target pixel. The comparing unit 706 is used for calculating a pixel difference value between the target pixel and a neighbor pixel having the same color with the target pixel. The determining unit 708 is used for comparing the STD with the noise threshold value to determine whether the neighbor pixel is a noise to the target pixel. The filter 710 is used for filtering out the noise to the target pixel via a pixel smooth operation. The window selecting unit 712 is used for defining a pixel window with a specific size according to a position of the target pixel. The pixel refreshing unit 714 is used for utilizing the pixel value calculated from the pixel smooth operation as a new pixel value of the target pixel.

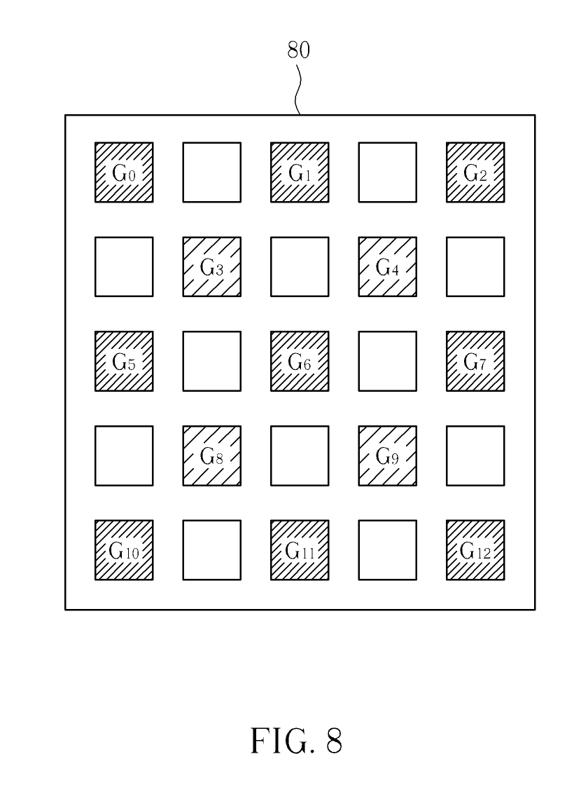

Operations of the noise processing device 70 are described as follows. After the selecting unit 702 of the noise processing device 70 has selected a pixel (i.e. the target pixel) from an original image (i.e. the image data captured by the image capturing device 100), the window selecting unit 712 defines a 5×5 pixel window centered from the position of the target pixel. Please refer to FIG. 8, which is a schematic diagram of a pixel window 80 according to an embodiment of the present invention. As shown in FIG. 8, assumed a selected target pixel G₆ is green, the pixels within the 5×5 pixel window and the pixels having the same color are neighbor pixels G₀-G₁₂. Noticeably, those skilled in the art should make modifications or alterations accordingly, and not limited to this. For example, the size of the pixel window is not limited to 5×5. The operating unit 704 calculates the noise threshold value of the target pixel G₆ according to the noise variation function formula, which is

Adaptive_Thr=REG_Min_STD+G₆×REG_Std_Percentage×REG_Lum_Slope×REG_ISO_Speed_Gain

Then, the comparing unit 706 calculates the pixel difference values between the target pixel G₆ and each neighbor pixels G₀, G₁, G₂, G₃, G₄, G₅, G₇, G₈, G₉, G₁₀, G₁₁, G₁₂ in order. Firstly, the comparing unit 706 calculates a first pixel difference value between the target pixel G₆ and the neighbor pixel G₀, and calculates a second pixel difference value between the target pixel G₆ and the neighbor pixel G₁, and so on. The determining unit 708 compares the first pixel difference value with the noise threshold value, if the first pixel difference value is less than the noise threshold value, the determining unit 708 determines the neighbor pixel G₀ is a noise of target pixel of noise; if the first pixel difference value is greater than the noise threshold value, the determining unit 708 determines the neighbor pixel G₀ is an edge pixel in stead of the noise. The determining unit 708 continuous to compare the second pixel difference value with the noise threshold value and so on, so as to determine whether each of the neighbor pixels is the noise according to the relationship between the pixel difference value and the noise threshold value. After the determining unit 708 has finished the procedure of determining whether the neighbor pixels G₀, G₁, G₂, G₃, G₄, G₅, G₇, G₈, G₉, G₁₀, G₁₁, G₁₂ are the noise, the filter 710 performs the pixel smooth operation to the neighbor pixels determined to be the noise to reduce the noise of the target pixel. More specifically, assumed that the determining unit 708 determined the neighbor pixels G₀, G₁, G₂, G₁₀, G₁₁, G₁₂ are the noise, the filter 710 sums the pixel value of the neighbor pixels G₀, G₁, G₂, G₁₀, G₁₁, G₁₂ to obtain a total pixel value to be divided by total number of the neighbor pixels, and thus calculates an average value. At last, the pixel refresh unit 714 utilizes the average value as a new pixel value of the target pixel G₆. Therefore, the noise around the target pixel G₆ is blurred, which is a result of the pixel smooth operation known in the art, detailed operation is omitted. Noticeably, in the embodiment, the determining unit 708 does not perform the pixel smooth operation to the neighbor pixels determined not to be the noise, and thus the sharpness of the target pixel is reserved, so as to achieve noise reduction or deduction of the target pixel.

Please note that the operation of noise reduction in the above embodiment is utilized for the green target pixel, however, the noise reduction process 20 may be suitable for the target pixel with other colors such as red or blue. Detailed operations can be obtained by referring to above description, which is omitted.

In short, the noise processing device 70 of the present invention dynamically calculates the suitable noise threshold value to reduce the noise in the image effectively. In addition, the noise threshold value may be adjusted according to the noise percentage and noise distribution, such that the noise processing device 70 reduces the noise in the image to achieve image optimization.

Besides, the noise reduction process 20 and/or the noise processing device 70 are not only designed and utilized in the image processing device 110, but also in the image capturing device 100. As a result, the noise may be removed before sending the image to the image processing system 10, so as to avoid the noise influence when the image processing device 110 performs the following specific image procedure, such as pixel compensation, color correction or image enhance.

To sum up, the traditional spatial filter can not distinguish the noise from the image signal, in contrast, the present invention can distinguish the noise from the image signal effectively. Therefore, the image data is reserved during the process of filtering the noise, and maintains the sharpness of the image. Moreover, the determination of the noise variation not only takes the luminance into consideration, e.g. the calculation of the bilateral filter, but also takes the luminance gain into consideration, and thus reduces the image noise effectively. Furthermore, the present invention is suitable for a single image in stead of continuous images to overcome the limit of system memory.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of noise reduction in an image, comprising:
capturing the image including a plurality of pixels each corresponding to a color via an image sensor;
selecting a target pixel of the plurality of pixels;
generating a noise threshold value associated to the target pixel according to a noise variation function related to noise distribution range of the image sensor;
calculating a difference value between the target pixel and a neighbor pixel having the same color with the target pixel;
comparing the difference value and the noise threshold value to determine whether the neighbor pixel is a noise to the target pixel; and
when determining the neighbor pixel is a noise to the target pixel, performing a smooth operation to lower the noise of the target pixel.

2. The method of claim 1, further comprising:
defining a pixel window with a specific size according to a position of the target pixel.

3. The method of claim 2, wherein the step of calculating the difference value between the target pixel and the neighbor pixel comprises:
calculating a difference value between the target pixel and each pixel having the same color with the target pixel in the pixel window.

4. The method of claim 3, wherein the step of comparing the difference value and the noise threshold value comprises:
comparing the difference value between the target pixel and each pixel with the noise threshold value respectively, to determine whether the pixel is a noise to the target pixel.

5. The method of claim 4, wherein the step of comparing the difference value between the target pixel and each pixel with the noise threshold value respectively comprises:
determining the pixel is the noise to the target pixel when the pixel difference value is less than the noise threshold value; and
determining the pixel is an image pixel instead of the noise to the target pixel when the pixel difference value is greater than the noise threshold value.

6. The method of claim 5, wherein the step of when determining the neighbor pixel is a noise to the target pixel, performing a smooth operation to lower the noise of the target pixel comprises:
when determining the pixel is the noise to the target pixel, utilizing a pixel value of the pixel and a pixel value of the target pixel to perform the pixel smooth operation, to lower the noise to the target pixel.

7. The method of claim 6, further comprising:
utilizing a pixel value calculated from the pixel smooth operation as a new pixel value of the target pixel.

8. The method of claim 1, wherein the noise variation function comprises a parameter related to a noise standard deviation and a luminance of the image sensor, a noise distribution probability parameter related to the image sensor, and a parameter related to a luminance gain compensation value and the noise standard deviation of the image sensor.

9. A noise processing device, for reducing a noise to an image captured by an image sensor, the noise processing device comprises:
a selecting unit for selecting a target pixel of a plurality of pixels each corresponding to a color in the image;
an operating unit for generating a noise threshold value associated to the target pixel according to a noise variation function related to a noise distribution range of the image sensor;
a comparing unit for calculating a pixel difference value of the target pixel and a neighbor pixel having the same color with the target pixel;
a determining unit for comparing the pixel difference value with the noise threshold value, to determine whether the neighbor pixel is the noise to the target pixel; and
a filter for performing a pixel smooth operation when the neighbor pixel is determined to be the noise to the target pixel, to lower the noise to the target pixel.

10. The noise processing device of claim 9, further comprising:
a window selecting unit for defining a pixel window with a specific size according to a position of the target pixel.

11. The noise processing device of claim 10, wherein the comparing unit is further used for calculating the pixel difference values between the target pixel and each pixel having the same color with the target pixel in the pixel window.

12. The noise processing device of claim 11, wherein the determining unit is further used for comparing the pixel difference value between the target pixel and each pixel with the noise threshold value respectively, to determine whether the pixel is the noise to the target pixel.

13. The noise processing device of claim 12, wherein the determining unit is further used for determining the pixel is the noise to the target pixel when the pixel difference value is less than the noise threshold value, and determining the pixel is an a image pixel in stead of the noise to the target pixel when the pixel difference value is greater than the noise threshold value.

14. The noise processing device of claim 13, wherein the filter is further used for when determining the pixel is the noise to the target pixel, utilizing a pixel value of the pixel and a pixel value of the target pixel to perform the pixel smooth operation, to lower the noise to the target pixel, and when the pixel is determined not to be the noise, neither the pixel value nor the target pixel value are used for performing the smooth operation, to maintain a sharpness of the image.

15. The noise processing device of claim 14, further comprising:
a pixel refresh unit for utilizing a pixel value calculated from the pixel smooth operation as a new pixel value of the target pixel.

16. The noise processing device of claim 9, wherein the noise variation function comprises a parameter related to a noise standard deviation and a luminance of the image sensor, a noise distribution probability parameter related to the image sensor, and a parameter related to a luminance gain compensation value and the noise standard deviation of the image sensor.

17. An image processing system, comprising:
an image capturing device comprising an image sensor for capturing an image including a plurality of pixels each corresponding to a color; and
an image processing device for receiving the image captured by the image capturing device, and performing at least one image procedure to the image, the image processing device comprises a noise processing device for reducing the noise to the image, the noise processing device comprising:
a selecting unit for selecting a target pixel of the plurality of pixels;
an operating unit for generating a noise threshold value associated to the target pixel according to a noise variation function related to a noise distribution range of the image sensor;
a comparing unit for calculating a pixel difference value of the target pixel and a neighbor pixel having the same color with the target pixel;
a determining unit for comparing the pixel difference value with the noise threshold value, to determine whether the neighbor pixel is the noise to the target pixel; and
a filter for performing a pixel smooth operation when the neighbor pixel is determined to be the noise to the target pixel, to lower the noise to the target pixel.

18. The image processing system of claim 17, wherein the noise processing device further comprises:
a window selecting unit for defining a pixel window with a specific size according to a position of the target pixel.

19. The image processing system of claim 18, wherein the comparing unit is further used for calculating the pixel difference values between the target pixel and each pixel having the same color with the target pixel in the pixel window.

20. The image processing system of claim 19, wherein the determining unit is further used for comparing the pixel difference value between the target pixel and each pixel with the noise threshold value respectively, to determine whether the pixel is the noise to the target pixel.

21. The image processing system of claim 20, wherein the determining unit is further used for determining the pixel is the noise to the target pixel when the pixel difference value is less than the noise threshold value, and determining the pixel is an a image pixel in stead of the noise to the target pixel when the pixel difference value is greater than the noise threshold value.

22. The image processing system of claim 21, wherein the filter is further used for when determining the pixel is the noise to the target pixel, utilizing a pixel value of the pixel and a pixel value of the target pixel to perform the pixel smooth operation, to lower the noise to the target pixel, and when the pixel is determined not to be the noise, neither the pixel value nor the target pixel value are used for performing the smooth operation, to maintain a sharpness of the image.

23. The image processing system of claim 22, wherein the noise processing device further comprises:
a pixel refresh unit for utilizing a pixel value calculated from the pixel smooth operation as a new pixel value of the target pixel.

24. The image processing system of claim 17, wherein the noise variation function comprises a parameter related to a noise standard deviation and a luminance of the image sensor, a noise distribution probability parameter related to the image sensor, and a parameter related to a luminance gain compensation value and the noise standard deviation of the image sensor.
